(19) United States
(12) Patent Application Publication
(10) Pub. No.: US 2008/0079691 A1
(43) Pub. Date: Apr. 3, 2008

(54) INFORMATION PROCESSING APPARATUS, TRANSMITTER, AND CONTROL METHOD

(75) Inventors: Hideo Kuboyama, Yokohama-shi (JP); Katsuhiko Kawasaki, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/855,773

(22) Filed: Sep. 14, 2007

(30) Foreign Application Priority Data
Oct. 3, 2006 (JP) 2006-271761

(51) Int. Cl. G09G 5/00

(52) U.S. Cl. 345/156

(57) ABSTRACT

An information processing apparatus including a switch configured to detect a first operation and a second operation and a display screen includes a first display control unit configured to display information on the display screen according to a first setting, a second display control unit configured to, when the first operation is detected by the switch, display information on the display screen according to a second setting that is set when the second operation is detected by the switch, and a third display control unit configured to shift from the first setting to the second setting when the second operation is detected after the first operation is detected and before the detected first operation is canceled, and to display information on the display screen according to the first setting when it is detected that the first operation is canceled while the second operation is not detected.

### BACKGROUND OF THE INVENTION

1. Field of the Invention

The present invention relates to an information processing apparatus configured to display information according to a user operation.

2. Description of the Related Art

With respect to information apparatuses, such as household electrical appliances or portable audio devices, it is important to secure a high user operability. In order to improve an operability of such an information apparatus, various conventional methods have been discussed. For example, with respect to an operation for selecting an item from a list, in a conventional method, a selection operation can be performed at a high speed using a wheel-shaped selection unit that can rotate according to a user operation. Another conventional method uses a touch sensor to allow a user to select an item from a list or to move a pointer.

As an information apparatus has a large number of functions, a user cannot easily understand which operation switch corresponds to which operation.

For example, a remote controller for a recent television set or a digital versatile disc (DVD) recorder has several tens of buttons, which make it difficult for a user to understand which operation switch corresponds to which operation.

In the case of a small apparatus, such as a digital camera, only a limited number of switches can be provided. Thus, a general key, such as a 4-directional pad, is provided with a plurality of functions. Thus, it is not easy for a user to understand which key corresponds to which operation.

A function of each button is described in a user's manual, of course. However, it is a burden on a user to be required to read a user's manual itself. Thus, a user may think that the operability is low about a function that the user cannot easily understand without referring to a user's manual.

Two methods, in a large sense, can address this problem.

Firstly, a method using a cancel button can be useful. In such a method, when a user presses a cancel button, an operation designated by a switch previously pressed is canceled and the processing returns to a previous state. Thus, in the case where a user has performed an operation that the user does not desire by pressing a wrong switch, the user can immediately cancel the wrong operation and restore a previous state.

Secondly, a method using a help function can be useful. In such a method, when a user presses each switch when an apparatus is set in a help mode, a description of an operation performed when the switch is pressed in a normal mode is notified to the user with a message displayed on a screen or with a sound message.

Japanese Patent Application Laid-Open No. 2003-70082 discusses a method for notifying a function to be executed according to a user operation of a switch with a message displayed on a screen or with a sound message. The method uses a switch including a sensor for detecting an access of a finger, a pressing level sensor, and a sensor for detecting two different pressing states.

With such a help function, a user can be notified of a function of a switch. However, the above-described conventional methods have the following problems.

That is, with respect to a conventional method using a cancel button, it is required to provide a switch for canceling a user operation.

In this regard, it is useful that a small-size apparatus or a remote control transmitter has as small number of switches as possible, in terms of the apparatus dimension and a total number of switches. It may be difficult to provide a switch for canceling a user operation, considering an apparatus dimension and the total number of switches.

With respect to a conventional method using a help function, a user may not always understand what operation is performed even if an operation or a function of a switch is described with a message on a display or with a sound message.

For example, if a message “changing the input . . . ” is displayed, a user cannot easily intuitively understand what the message actually refers to. Accordingly, a method is useful that can notify a user of an operation performed when the user presses a switch before the switch is actually pressed and that allows the user to easily cancel the notified operation.

### SUMMARY OF THE INVENTION

The present invention is directed to an information processing apparatus capable of displaying and notifying a user of information about what operation is performed when a user presses a switch, before the user presses the switch, with which a user can easily cancel a once-designated operation.

According to an aspect of the present invention, an information processing apparatus including a switch configured to detect a first operation and a second operation and a display screen includes a first display control unit configured to display information on the display screen according to a first setting; a second display control unit configured to, when the first operation is detected by the switch, display information on the display screen according to a second setting that is set when the second operation is detected by the switch; and a third display control unit configured to shift from the first setting to the second setting when the second operation is detected after the first operation is detected and before the detected first operation is canceled, and to display information on the display screen according to the first setting when it is detected that the first operation is canceled while the second operation is not detected.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principle of the invention.

FIG. 1 illustrates an exemplary hardware configuration of an information processing apparatus according to an exemplary embodiment of the present invention.

FIG. 2 is a flow chart illustrating an exemplary flow of processing performed by the information processing apparatus according to an exemplary embodiment of the present invention.

FIG. 3 illustrates an example of a method of using a switch according to a first exemplary embodiment of the present invention.

FIG. 4 illustrates an example of a method of using a switch according to a second exemplary embodiment of the present invention.

FIG. 5 illustrates an example of a method of using a switch according to a third exemplary embodiment of the present invention.

FIG. 6 illustrates an example of a method of using a switch according to a fourth exemplary embodiment of the present invention.

FIG. 7 illustrates an example of a method of using a switch according to a fifth exemplary embodiment of the present invention.

### DETAILED DESCRIPTION OF THE EMBODIMENTS

Various exemplary embodiments, features, and aspects of the present invention will now herein be described in detail with reference to the drawings. It is to be noted that the relative arrangement of the components, the numerical expressions, and numerical values set forth in these embodiments are not intended to limit the scope of the present invention unless it is specifically stated otherwise.

### First Exemplary Embodiment

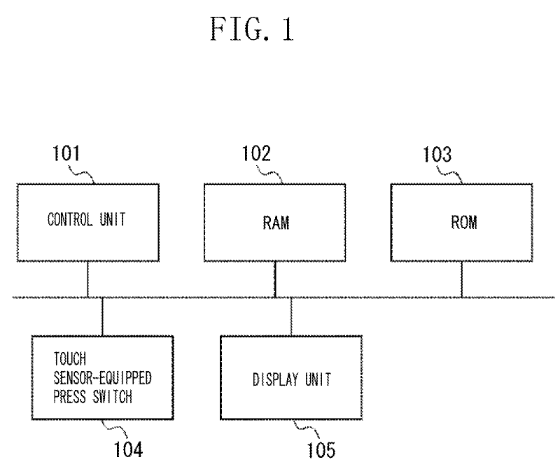

Now, a first exemplary embodiment of the present invention will be described below. FIG. 1 illustrates an exemplary hardware configuration of an information processing apparatus according to the first exemplary embodiment of the present invention.

Referring to FIG. 1, the information processing apparatus includes a control unit 101, a random access memory (RAM) 102, a read-only memory (ROM) 103, a touch sensor-equipped press switch 104, and a display unit 105.

The control unit 101 executes an application program, an operating system (OS), and a control program stored in the ROM 103. Furthermore, the control unit 101 temporarily stores information and a file necessary for executing a program in the RAM 102. The RAM 102 temporarily stores various data. The RAM 102 also serves as a main memory and a work memory for the control unit 101. The ROM 103 includes a boot ROM and stores a boot program (basic input/output (I/O) program) for the system. The ROM 103 also stores various data used in basic (system boot) processing.

The touch sensor-equipped press switch 104 includes, on its surface, a touch sensor for detecting that a user touches the touch sensor-equipped press switch 104 with his/her finger. The touch sensor-equipped press switch 104 can also be pressed to operate. The touch sensor-equipped press switch 104 is capable of detecting two user operations, namely, a touching operation and a pressing operation. The control unit 101 controls a display according to a user operation on the touch sensor-equipped press switch 104. The display unit 105 displays various data and information, such as image data, apparatus information, information about the image data, information about a user operation, and information about a function of the information processing apparatus.

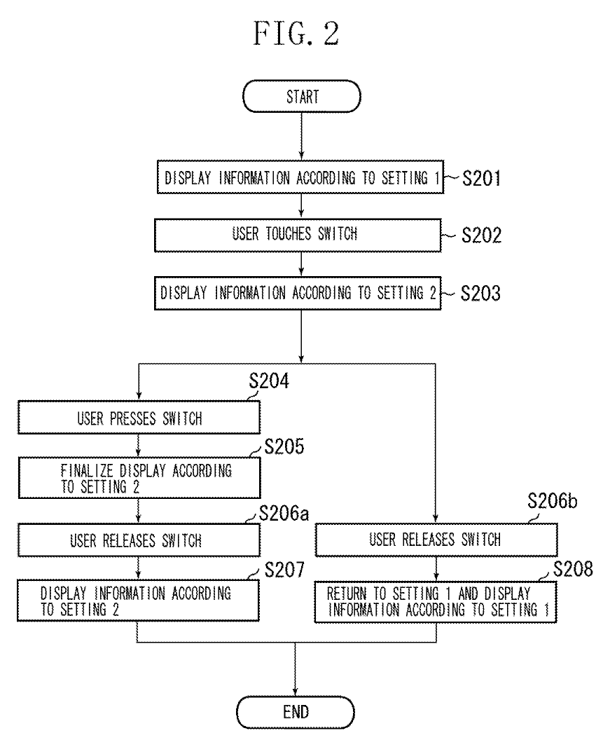

FIG. 2 is a flow chart illustrating an exemplary flow of processing performed by the information processing apparatus according to the first exemplary embodiment of the present invention.

Hereinbelow, an operation performed according to the present exemplary embodiment will be described with reference to FIGS. 1 and 2.

In step S201 illustrated in FIG. 2, the control unit 101 displays information on the display unit 105 according to a specific setting 1. In step S202, a user touches the touch sensor-equipped press switch 104.

In step S203, the control unit 101 outputs information to the display unit 105 according to a setting 2, which is a setting to which the control unit 101 shifts after a function of the touch sensor-equipped press switch 104 is executed with the user operation on the touch sensor-equipped press switch 104. In step S204, the user presses the touch sensor-equipped press switch 104. In step S205, the control unit 101 finally applies the setting 2, and outputs information to the display unit 105 according to the setting 2.

In step S206a, the user releases the touch sensor-equipped press switch 104. In step S207, since the setting 2 has been finally applied, the control unit 101 outputs information to the display unit 105 according to the setting 2.

On the other hand, if the user releases the touch sensor-equipped press switch 104 in step S206b without pressing the touch sensor-equipped press switch 104 after the processing in step S203 is performed, then the control unit 101 returns to the setting 1 and displays information on the display unit 105 according to the setting 1 in step S208.

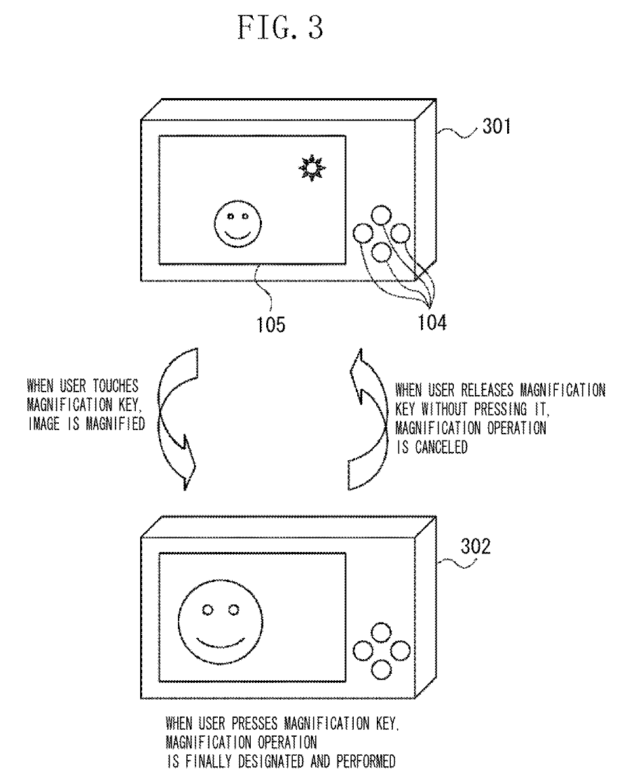

FIG. 3 illustrates an example of a state in which the display on the information processing apparatus is actually changed, according to the present exemplary embodiment.

Referring to FIG. 3, in a state 301, the information processing apparatus displays information according to the setting 1. In a state 302, the information processing apparatus displays information according to the setting 2. The information processing apparatus includes the touch sensor-equipped press switch 104, as described above.

In the example illustrated in FIG. 3, in the state 301, the information processing apparatus currently displays an image. When a user touches a magnification key for performing a magnification operation of the touch sensor-equipped press switch 104 in the state 301, the information processing apparatus performs an image magnifying operation and displays the magnified image, as in the state 302.

When the user presses the magnification key, the control unit 101 finally applies the state after the magnification operation is performed as in the state 302, and the display of the magnified image on the display unit 105 is kept. On the other hand, when the user releases the magnification key without pressing the magnification key, the magnification operation is cancelled and the control unit 101 returns to the state 301 to display again an image before magnification on the display unit 105.

As described above, according to the present exemplary embodiment, the user can easily perform a final designation and canceling of a user operation via the same switch (the touch sensor-equipped press switch 104) while verifying a display provided according to an operation on the switch.

The application of the present exemplary embodiment is not limited to a display of a magnified image, and the present invention can be applied to various applications.

### Second Exemplary Embodiment

In the example illustrated in FIG. 3 according to the first exemplary embodiment, the switch 104 includes a touch sensor, and when the user touches the touch sensor-equipped press switch 104 (a first operation), the control unit 101 shifts from the setting 1 to the setting 2. Then, the control unit 101 displays an image according to the setting 2, and finally applies the user operation according to pressing the touch sensor-equipped press switch 104 (a second operation). When the user releases the touch sensor-equipped press switch 104 without pressing it, the control unit 101 cancels the user operation. However, the present invention is not limited to this. The first operation can be such a user operation that the user touches the touch sensor with his/her finger and then slides his/her finger on the touch sensor. The finger-sliding operation on the touch sensor and, namely, an amount of movement of the user operation, can be detected by the touch sensor.

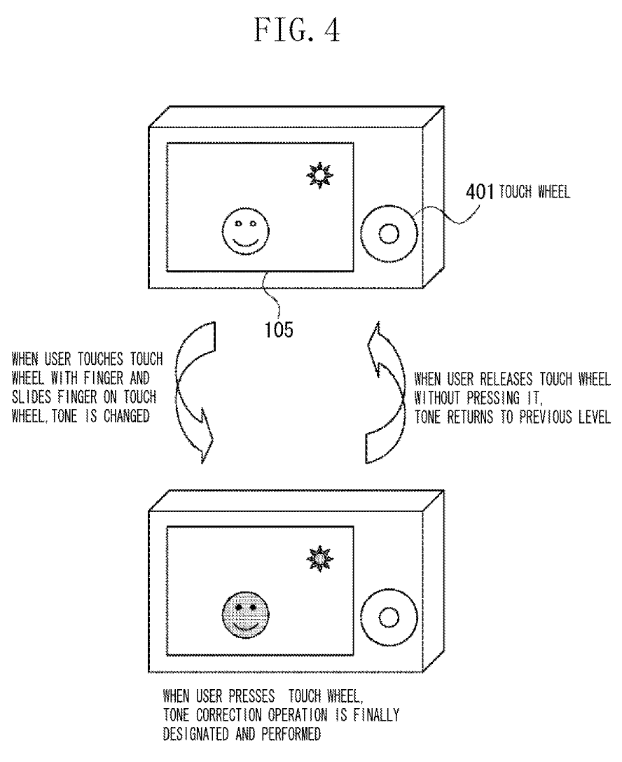

FIG. 4 illustrates an example of a method of using a switch according to the second exemplary embodiment of the present invention.

Referring to FIG. 4, a wheel-shaped touch wheel 401 includes a touch sensor on a surface thereof. A user can press the touch wheel 401 at four positions, namely, up, down, left, and right positions. In the example illustrated in FIG. 4, an image is displayed on the display unit 105, and the user desires to correct a tone of the displayed image.

When the user touches the touch wheel 401 and slides his/her finger along the surface of the touch wheel 401, the touch wheel 401 detects the amount of movement of the finger-sliding operation by the user. The user can shift between tone levels listed in a tone table by adjusting an amount of movement of the finger-sliding operation on the touch wheel 401. Thus, the tone of the image displayed on the display unit 105 can be changed according to the amount of movement of the finger-sliding operation.

When the user presses the touch wheel 401, the tone applied at the time of pressing the touch wheel 401 is finally applied. On the other hand, if the user releases the touch wheel 401 without pressing it, the display unit 105 displays the image in a state before the tone is changed.

The present exemplary embodiment is not limited to the tone correction operation.

For example, the present exemplary embodiment can have such a configuration that when the user slides his/her finger on the touch wheel 401 in the case of performing a slide show of still images or reproducing a moving image, the still images or the moving image can be displayed or reproduced in a fast forward or a backward mode according to the direction of the finger-sliding operation on the touch wheel 401. When the user presses the touch wheel 401, a displayed image is finally designated, and the image displayed on the display unit 105 at the time of pressing the touch wheel 401 continues being displayed. If the user releases the touch wheel 401 without pressing it, an image displayed before the user performs the finger-sliding operation on the touch wheel 401 is displayed again.

As described above, the present exemplary embodiment can be applied to various applications.

### Third Exemplary Embodiment

In the above-described first and second exemplary embodiments, the information processing apparatus configured to display information on the display unit 105 includes a touch sensor-equipped press switch. However, the present invention is not limited to this configuration. That is, the information processing apparatus can be applied to a remote control apparatus. A third exemplary embodiment of the present invention relates to a method for operating an information processing apparatus with a remote control apparatus.

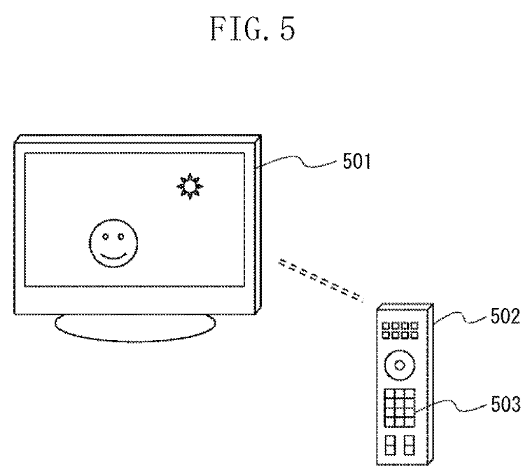

FIG. 5 illustrates an example of a method of using a switch (remote control apparatus) according to the third exemplary embodiment.

Referring to FIG. 5, a television set 501 displays a video image of a television broadcast. A remote control apparatus 502 can be operated by a user to operate the television set 501.

A channel switch 503 can be operated by a user to call up a channel or shift from one channel to another. The channel switch 503 is a press switch and includes a touch sensor on its surface, just as the touch sensor-equipped press switch 104 in the first exemplary embodiment.

When a user touches the channel switch 503, the remote control apparatus 502 transmits a signal to the television set 501 to control and cause the television set 501 to display the channel designated by the user.

When the user presses the channel switch 503 at this timing, the remote control apparatus 502 transmits a signal to the television set 501 to instruct the television set 501 to finally apply the channel designated by the user. On the other hand, if the user releases the channel switch 503 without pressing it, the remote control apparatus 502 transmits a signal to the television set 501 to cause the television set 501 to display a video image corresponding to the previously designated channel.

However, the configuration of the present exemplary embodiment is not limited to this. That is, the present exemplary embodiment can be configured such that the remote control apparatus 502 does not transmit a control signal for finally applying the operation designated by the user via the remote control apparatus 502. Furthermore, the television set 501 can perform a determination as to whether the once designated setting is to be cancelled.

In this case, when the user touches the channel switch 503, the remote control apparatus 502 transmits to the television set 501 a signal for instructing the television set 501 to shift to the newly designated channel and to display a video image corresponding to the channel designated by the user. When the user presses the channel switch 503 in this state, the remote control apparatus 502 transmits to the television set 501 a signal for causing the television set 501 to finally apply the user operation and to continue displaying a video image corresponding to the designated channel.

When the user releases the channel switch 503, regardless of whether the user has pressed the channel switch 503, the remote control apparatus 502 transmits a signal for causing the television set 501 to cancel the current setting and return to the previously displayed channel. In this case, if the television set 501 has received a control signal for finally applying the setting for the channel switch 503 immediately before the remote control apparatus 502 transmits the signal for causing the television set 501 to cancel the current setting and to return to the previously displayed channel, the television set 501 ignores the control signal for canceling the setting.

The following operation can be performed with either of the above-described configurations.

For example, when the user touches the channel switch 503 for a “channel 8”, the television set 501 displays a TV broadcast video image corresponding to the channel 8.

When the user presses the channel switch 503 in this state, the television set 501 finally applies the channel 8. If the user releases the channel switch 503, the television set 501 continues displaying a video image corresponding to the channel 8. On the other hand, when the user releases the channel switch 503 without pressing it, the display returns from the channel 8 to the previously selected channel.

As described above, according to the present exemplary embodiment, the user can simulate what operation is performed when pressing the channel switch 503, finally apply the operation, and cancel the operation, by continuously operating the remote control apparatus 502. Thus, the user operability can be improved.

### Fourth Exemplary Embodiment

In the above-described first, second, and third exemplary embodiments, when a user touches a switch by the first operation, the information processing apparatus displays an image according to a setting applied when the user finally applies it by pressing the switch by a second operation, on the same display screen as the screen on which the image designated by the second operation. However, the present invention is not limited to this.

That is, different screens can be used as the display screen for displaying an image designated by each of the first and second operations.

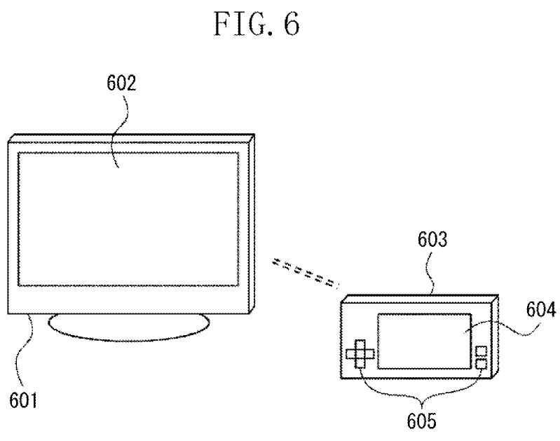

FIG. 6 illustrates an example in which different screens can be used as the display screen for displaying an image designated by each of the first and second operations, according to a fourth exemplary embodiment of the present invention.

Referring to FIG. 6, a display 601 displays information. The display 601 includes a display screen 602. A remote control apparatus 603 can be operated by a user to operate the display 601.

The remote control apparatus 603 includes a remote display screen 604 configured to displays information and a press switch 605. The press switch 605 includes a touch sensor on a surface thereof.

In the example illustrated in FIG. 6, when the user touches the press switch 605, the remote control apparatus 603 displays information on the remote display screen 604 according to a setting corresponding to the press switch 605.

When the user presses the press switch 605 in this state, the remote control apparatus 603 transmits to the display 601 a control signal for instructing the display 601 to finally apply the setting corresponding to the press switch 605. Then, the display 601 displays information on the display screen 602 according to the setting corresponding to the control signal sent from the remote control apparatus 603.

### Fifth Exemplary Embodiment

In the above-described exemplary embodiments, when the user touches a switch by the first operation, the information processing apparatus changes the setting according to the operation set for the switch. Furthermore, the information processing apparatus applies the setting by the second operation, and cancels the setting when the user releases the switch without performing the second operation.

In a fifth exemplary embodiment of the present invention, when the user touches a switch by the first operation, a remote control apparatus performs speech recognition. Then, the remote control apparatus changes the setting according to a result of the speech recognition, finally applies the setting when the user performs the second operation. When the user releases the switch, the setting is canceled.

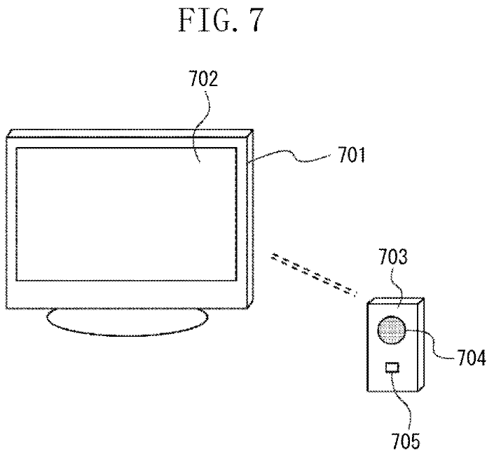

FIG. 7 illustrates an example of a method of using a switch utilizing speech recognition according to the fifth exemplary embodiment of the present invention.

Referring to FIG. 7, a display 701 displays information. The display 701 includes a display screen 702. A remote control apparatus 703 can be operated by a user to operate the display 701. The remote control apparatus 703 includes a microphone 704 and a press switch 705

A user can input speech information via the microphone 704. The press switch 705 includes a touch sensor on a surface thereof.

When a user touches the press switch 705, speech information is captured (input) via the microphone 704. Then, the input speech information is recognized by speech recognition processing, and the recognized speech information is converted into a command for controlling a setting.

The remote control apparatus 703 can perform speech recognition and transmit the control command to the display 701. Alternatively, the remote control apparatus 703 can transmit the input speech information to the display 701 and the display 701 can perform speech recognition on the received speech information.

The display 701 displays an image on the display screen 702 according to the setting for the control command.

When the user presses the press switch 705 in this state, the setting for the control command according to a result of the speech recognition is finally applied. On the other hand, when the user releases the press switch 705 without pressing it, the display 701 cancels the setting for the control command applied according to the result of the speech recognition. Then, the display 701 restores the previous setting and displays the previously displayed image on the display screen 702.

### Sixth Exemplary Embodiment

In each of the first through fifth exemplary embodiments, the switch (the touch sensor-equipped press switch 104, the touch wheel 401, the channel switch 503, the press switch 605, or the press switch 705) includes a touch sensor. However, the present invention is not limited to this. That is, a switch configured to detect a plurality of different types of user operations can be used.

For example, a switch that can be pressed in two different states or a lever that can be pushed or pressed at a plurality of different levels can be used.

### Seventh Exemplary Embodiment

In each of the above-described first through sixth exemplary embodiments, when the user releases the switch, the information processing apparatus determines that the current setting has been designated to be canceled. However, the present invention is not limited to this. That is, the setting can be canceled when a predetermined period of time has elapsed after the release of the switch.

For example, in the case of shifting between channels illustrated in FIG. 5, when the user is currently touching the channel switch 503 for channel 8 and operates the channel switch 503 for channel 10, the operability is low if the television set 501 returns to a previously designated channel immediately after the user releases the channel switch 503 for the channel 8.

In this regard, in a seventh exemplary embodiment of the present invention, the setting is not canceled for a predetermined period of time after the user has released the channel switch 503. Thus, the user can serially shift from one channel to another every time the user touches a channel key, in such a manner of shifting from the channel 8, then to the channel 10, and then to channel 6, without returning to the previously designated channel.

Thus, the user can touch one switch after another to verify each channel and press the switch for a channel as the user desires to finally designate the desired channel. If the user does not desire to designate a channel, the user can release the switch. In this case, after the user has released the switch, the display returns to the channel that has been designated before the above-described user operation, after the predetermined period of time has elapsed.

### Other Exemplary Embodiments

The present invention can also be achieved by providing a system or an apparatus with a storage medium storing program code of software implementing the functions of the embodiments and by reading and executing the program code stored in the storage medium with a computer of the system or the apparatus (a CPU or a micro processing unit (MPU)).

In this case, the program code itself, which is read from the storage medium, implements the functions of the embodiments described above, and accordingly, the storage medium storing the program code constitutes the present invention.

Accordingly, the program can be configured in any form, such as object code, a program executed by an interpreter, and script data supplied to an operating system (OS).

As the storage medium for supplying such program code, a floppy disk, a hard disk, an optical disk, a magneto-optical disk (MO), a compact disk read-only memory (CD-ROM), a compact disk recordable (CD-R), a compact disk rewritable (CD-RW), a magnetic tape, a nonvolatile memory card, a read-only memory (ROM), and a digital versatile disc (DVD) (DVD-recordable (DVD-R), DVD-rewritable (DVD-RW)), for example, can be used.

In addition, the functions according to the embodiments described above can be implemented not only by executing the program code read by the computer, but also implemented by the processing in which an OS or the like carries out a part of or the whole of the actual processing based on an instruction given by the program code.

Furthermore, in another exemplary embodiment of the present invention, after the program code read from the storage medium is written in a memory provided in a function expansion board inserted in a computer or a function expansion unit connected to the computer, a CPU provided in the function expansion board or the function expansion unit carries out a part of or the whole of the processing to implement the functions of the embodiments described above.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2006-271761 filed Oct. 3, 2006, which is hereby incorporated by reference herein in its entirety.

What is claimed is:

1. An information processing apparatus including a switch configured to detect a first operation and a second operation and a display screen, the information processing apparatus comprising:
a first display control unit configured to display information on the display screen according to a first setting;
a second display control unit configured to, when the first operation is detected by the switch, display information on the display screen according to a second setting that is set when the second operation is detected by the switch; and
a third display control unit configured to shift from the first setting to the second setting when the second operation is detected after the first operation is detected and before the detected first operation is canceled, and to display information on the display screen according to the first setting when it is detected that the first operation is canceled while the second operation is not detected.

2. The information processing apparatus according to claim 1, wherein the first operation includes touching the switch, and
wherein the second operation includes pressing the switch.

3. The information processing apparatus according to claim 1, wherein the first operation includes detecting an amount of movement of a portion of the switch at which the switch is touched, and
wherein the second operation includes pressing the switch.

4. The information processing apparatus according to claim 1, wherein the switch is configured to be pressed at two or more different levels:
wherein the first operation includes pressing the switch up to a predetermined level; and
wherein the second operation includes further pressing the switch beyond the predetermined level.

5. The information processing apparatus according to claim 1, wherein it is detected that the first operation is canceled when a predetermined period of time has elapsed after the first operation of the switch is canceled.

6. An information processing apparatus including a switch configured to detect a first operation and a second operation, a display screen configured to display information, and a speech input unit, the information processing apparatus comprising:
a speech recognition unit configured to recognize speech input via the speech input unit;
a first display control unit configured to display information on the display screen according to a first setting;
a second display control unit configured to, when the first operation is detected by the switch, display information on the display screen according to a second setting that is set based on a result of speech recognition performed by the speech recognition unit; and
a third display control unit configured to shift from the first setting to the second setting when the second operation is detected after the first operation is detected and before the detected first operation is canceled, and to display information on the display screen according to the first setting when it is detected that the first operation is canceled while the second operation is not detected.

7. A transmitter including a switch configured to detect a first operation and a second operation, the transmitter comprising:
a first transmitting unit configured to, when the first operation is detected by the switch, transmit a control signal for instructing displaying information according to a setting that is set when the second operation is detected by the switch; and
a second transmitting unit configured to transmit control information for restoring a previous setting when, after the first operation is detected by the switch, it is detected that the first operation is canceled while the second operation is not detected.

8. The transmitter according to claim 7, further comprising a third transmitting unit configured to transmit a control signal for finally applying the setting when, after the first operation is detected by the switch, the second operation is detected by the switch.

9. A transmitter including a switch configured to detect a first operation and a second operation and a display screen configured to display information, the transmitter comprising:
a first display control unit configured to, when the first operation is detected by the switch, display information on the display screen according to a setting that is set when the second operation is detected by the switch;
a transmitting unit configured to transmit a control signal for finally applying the setting when, after the first operation is detected by the switch, the second operation is detected by the switch; and
a second display control unit configured to cause the first display control unit to restore a previous display when, after the first operation is detected by the switch, it is detected that the first operation is canceled while the second operation is not detected.

10. A transmitter including a switch configured to detect a first operation and a second operation and a speech input unit, the transmitter comprising:
a first transmitting unit configured to, when the first operation is detected by the switch, transmit speech input via the speech input unit and to transmit a control signal for instructing performing speech recognition; and
a second transmitting unit configured to transmit a control signal for finally applying a setting that is set based on a result of the speech recognition when, after the first operation is detected by the switch, the second operation is detected by the switch, and to transmit control information for restoring a previous setting when, after the first operation is detected by the switch, it is detected that the first operation is canceled while the second operation is not detected.
